(19) United States
(12) Patent Application Publication
(10) Pub. No.: US 2015/0324829 A1
(43) Pub. Date: Nov. 12, 2015

(54) SYSTEMS AND METHODS FOR OPERATING A LOYALTY PLATFORM FOR GAMES AND INTERNET-CONNECTED APPLICATIONS

(71) Applicant: Yvolver, Inc., Dallas, TX (US)

(72) Inventors: Matthew M. Himelfarb, Dallas, TX (US); Stephen S. Nix, Dallas, TX (US); Jah A. Raphael, Dallas, TX (US); Cory D. Lewis, Austin, TX (US)

(21) Appl. No.: 14/274,020

(22) Filed: May 9, 2014

(51) Int. Cl. G06Q 30/02

(52) U.S. Cl. CPC G06Q 30/0226

(57) ABSTRACT

Systems and methods for operating a loyalty platform for Internet-connected applications that may be utilized on a plurality of hardware platforms are provided. These systems may include a points, status and rewards administration center communicating with one or more Internet-connected applications. Users may be presented with opportunities to earn modifiers that may drive specific user behavior in an Internet-connected application, including but not limited to influencing the user to purchase items within the Internet-connected application, increase his/her usage of the Internet-connected application, or complete certain activities within the Internet-connected application. The system's administration center may maintain information on users' behaviors, points, rewards and status across a plurality of Internet-connected applications that may be synced with the system and, based on a system of predictive analytics, may automatically present incentive recommendations to the developer of each Internet-connected application for one or more users.

### FIELD OF THE DISCLOSURE

The present disclosure generally relates to a loyalty platform, and more particularly to a loyalty platform for games and/or Internet-connected applications.

### BACKGROUND

Smartphone penetration is rapidly increasing, and approximately 51% of smartphone users play games using their smartphones. Games dominate the mobile download market and revenues associated with the market. Developers of Internet-connected applications, such as games, want to encourage users to begin to or continue to utilize their applications. User retention is important as it can be costly to acquire new users (generally more than $3 per installation to acquire a new user), and the cost is increasing rapidly. It is up to the developer to retain quality users that will spend money related to an Internet-connected application, and this has generally been done through in-application features, compulsion loops, and user messaging. Some developers try to influence user behavior by offering rewards for certain behaviors within an application. However, the rewards that are offered typically focus on offering discounts or coupons that may not necessarily drive users to spend money in connection with the application, and these actions may still not retain high value users on an Internet-connected application.

### SUMMARY

Embodiments of the present disclosure may provide systems for operating a loyalty platform for an Internet-connected application, the systems comprising a points, status and rewards administration center housed on one or more servers, and accessing one or more databases to manage events, activities within the events, modifiers, user spend and rewards on the Internet-connected application, wherein the administration center may provide a user of the Internet-connected application with opportunities to earn one or more modifiers based on completion of one or more activities within an event that, when combined with the user spend within the Internet-connected application, may influence present and future user activity within the Internet-connected application. The Internet-connected application may be utilized by a user on at least one hardware platform, the at least one hardware platform selected from the group comprising: a mobile communication device, a tablet, a laptop computer, a personal computer, a personal digital assistant, an augmented/ virtual reality device, and a video game console. The one or more modifiers may be selected from the group comprising: a multiplier, a status, points, an additive percentage, and combinations of the same. User activity may comprise making purchases within the Internet-connected application, increasing usage of the Internet-connected application, and completing activities within the Internet-connected application. The points, status and rewards administration center may comprise a public portal displayed within the Internet-connected application to the user; a developer portal to manage events and rewards associated with the Internet-connected application; and an entitlement portal housing the business logic for the points, status and rewards administration center, the business logic comprising management of events associated with the Internet-connected application, rewards, points, modifiers, activities eligible for modifiers, and in-application purchases. The public portal, the developer portal and/or the entitlement portal may access one or more third-party services, the one or more third-party services selected from the group comprising: order fulfillment, receipt validation, payment processing, and event log storage. The points, status and rewards administration center may further comprise a logging and analytics system that may track user activity and query system analytics related to the Internet-connected application.

Other embodiments of the present disclosure may provide systems for managing rewards for use of an Internet-connected application, the systems comprising one or more client side devices accessing the Internet-connected application over a communication network to view events, earn modifiers, and make in-application purchases, that when combined, result in a score that is redeemable for the rewards for use of the Internet-connected application; a service stack having one or more servers that communicate with the one or more client side devices accessing the Internet-connected application, wherein the service stack manages the events, modifiers, in-application purchases, and rewards associated with the Internet-connected application; and one or more databases accessed by the service stack to store and access information related to usage of the Internet-connected application by the one or more client side devices. The one or more client side devices may be selected from the group comprising: a mobile communication device, a laptop computer, a personal computer, a tablet, an augmented/virtual reality device, a personal digital assistant, and a video game console. The events associated with the Internet-connected application may be available for a specified period of time. The score may comprise the modifier within the Internet-connected application based on user achievement associated with the event multiplied by the value of the in-application purchases. The rewards may be digital and physical items.

Further embodiments of the present disclosure may provide methods for operating a loyalty platform for one or more Internet-connected applications, the methods comprising providing a user with a threshold for use of the one or more Internet-connected applications over a specified period of time; awarding a user with a modifier when the user reaches the threshold for use of the one or more Internet-connected applications over the specified period of time; prompting the user to make one or more in-application purchases; combining the modifier with the dollar value of the one or more in-application purchases to assign the user a score, wherein the score is redeemed for one or more rewards, wherein the threshold, the modifier, and the one or more in-application purchases made by the user are stored on one or more databases accessed over a communication network and are managed on a service stack. The specified period of time may be selected from the group comprising: an hour, a day, a week, a month, a quarter, and a year. The prompting step may be performed by providing the user with a notification on the hardware platform used to access the one or more Internet-connected applications. The user may be awarded a modifier by reaching the threshold from use of a single Internet-connected application. The user may be awarded a modifier by reaching the threshold based on use of more than one Internet-connected application. The one or more rewards may be digital and physical items. The method may further comprise using the service stack, tracking device and user activity and predicting future user behavior related to the one or more Internet-connected applications. User activity may comprise purchase of items within the one or more Internet-connected applications, increase in usage of the one or more Internet-connected applications, and completion of activities within the one or more Internet-connected applications.

### BRIEF DESCRIPTION OF THE DRAWINGS

For a more complete understanding of this disclosure, reference is now made to the following description, taken in conjunction with the accompanying drawings, in which:

FIG. 1 depicts a network services diagram of a system for operating a loyalty platform according to an embodiment of the present disclosure;

FIG. 2 depicts a flow chart of how a user score may be achieved according to an embodiment of the present disclosure;

FIG. 3 depicts a screenshot of a notification of an event and opportunity to earn a modifier related to the event that may be provided to a new user according to an embodiment of the present disclosure;

FIG. 4 depicts a screenshot of what a new user may see if he/she makes an in-application purchase according to an embodiment of the present disclosure;

FIG. 5A depicts a screenshot of an events screen for a new user, the events screen depicting incomplete and complete activities for a specified period of time, according to an embodiment of the present disclosure;

FIG. 5B depicts a screenshot of what a new user may see if he/she views a catalog of available rewards on an events screen according to an embodiment of the present disclosure;

FIG. 6A depicts a screenshot of an events screen for an existing user, the events screen depicting incomplete and complete activities for a specified period of time, according to an embodiment of the present disclosure;

FIG. 6B depicts a screenshot of what an existing user may see if he/she views a catalog of available rewards on an events screen according to an embodiment of the present disclosure; and

FIG. 6C depicts a screenshot allowing the existing user to confirm that he/she wishes to redeem the reward selected in FIG. 6B according to an embodiment of the present disclosure.

### DETAILED DESCRIPTION

Embodiments of the present disclosure may provide systems and methods for operating a loyalty and rewards platform for games and other Internet-connected applications that may be utilized on a plurality of hardware platforms. In embodiments of the present disclosure, a user may be made aware of an event, the event being comprised of one or more activities that a user may perform. In some embodiments of the present disclosure, events may be referred to as promotions and vice versa. As a user completes an activity, he/she may be awarded a bonus. In some embodiments of the present disclosure, that bonus may be a modifier. When the term “modifier” is used, it should be appreciated that it may include but is not limited to a multiplier, a status, points, an additive percentage, and/or combinations of the same. It also should be appreciated that a modifier may be something that affects a user's score and could affect other bonuses that a user may achieve without departing from the present disclosure.

Systems according to embodiments of the present disclosure include a points, status and rewards administration center communicating over a communication network with one or more Internet-connected applications that may be utilized on a plurality of hardware platforms. Systems according to embodiments of the present disclosure may incentivize user behavior by automatically rewarding certain user behavior with bonuses, including modifiers, that may be intended to monetarily benefit the developer or publisher of such Internet-connected applications. A system's administration center may maintain information on users' behaviors, points, rewards and status across a plurality of Internet-connected applications that may be synced with the system and may automatically present incentive recommendations to the developer of each Internet-connected application for one or more users. In these systems, users of Internet-connected applications may be presented with opportunities to earn modifiers that may drive specific user behavior in an Internet-connected application, including but not limited to influencing the user to make in-application purchases, increase his/her usage of the Internet-connected application, or complete certain activities related to the Internet-connected application.

Users may build up their respective scores by achieving a modifier through completing activities forming part of an event that may be established by the developer in combination with the user making in-application purchases. When users engage with one or more Internet-connected applications in ways desired by a developer, the user's level of engagement may result in points that, when combined with the user's in-application spend, may result in a score. The more that the user engages in desired behaviors related to the application and also engages in in-application spend, the higher the user's score will be, and the more digital and/or physical rewards may be available to the user to redeem for purchase. Users may increase their respective scores by completing activities in connection with an event that may be established by the developer in combination with the user making in-application purchases. As a result of completing these activities, the user may be awarded a modifier that may affect the user's score. Predictive analytics may assist developers to pull the best levers to deliver maximum value for users of their respective Internet-connected applications while also driving specific user in-application behaviors that may be critical to an application's success. Thus, through systems and methods according to embodiments of the present disclosure, developers may retain and engage the users that they already have while also monetizing new users.

As will be described in more detail below, the user's score may be established over a specified period of time as set by the developer. In embodiments of the present disclosure, the user's score may reset each week, month, or another desired period of time. Once a user reaches a certain score associated with one or more Internet-connected applications and the user also spends a threshold amount on in-application purchases, the user may convert his/her score into rewards, such as digital in-application items or power-ups and/or physical real-world rewards, including but not limited to electronics, accessories, clothing, custom-branded items, and other goods. As will be described in more detail below, it should be appreciated that the user's score may be limited to use of a single Internet-connected application or may be persistent across more than one Internet-connected application without departing from the present disclosure. The user's score also may be accumulated regardless whether a user utilizes a single hardware platform (such as his/her smartphone) or more than one platform to access the one or more Internet-connected applications according to embodiments of the present disclosure.

It should be appreciated that developers may receive a number of benefits from systems and methods according to embodiments of the present disclosure. These benefits may include, but are not limited to, increased in-application monetization and user long-term value, increased customer retention, increased conversion from non-spending to spending users, differentiation of products in a crowded market, segmentation and targeting of users based on use and spend behaviors across various applications and hardware platforms, and in-depth predictive analytics based on real user behavior. More specifically, by providing users with ways to achieve points toward a score that may translate to the ability to purchase quality rewards, the developer may realize increased user retention. The developer also may realize increased in-application monetization (i.e., users spending money within the application) and a higher net profit that may be achieved over the course of the relationship with the user. This may improve the leaky money bucket situation for developers insofar as acquisition dollars invested in an application may encourage retention, engagement and in-application spend for users once acquired. Cross-promotions may be done across one or more Internet-connected applications, and this also may lead to further customer acquisition. Systems and methods according to embodiments of the present disclosure may allow a developer to differentiate its product offerings in a crowded marketplace. The developer also may segment and target customers based on play and spend behaviors across applications and hardware platforms.

Users of games and Internet-connected applications employing systems and methods according to embodiments of the present disclosure also may receive a number of benefits. These benefits may include, but are not limited to, the ability to earn modifiers within an application to increase their respective scores, and access to a catalog of high-quality physical and/or digital rewards (as opposed to ads or offers), as will be described in more detail below.

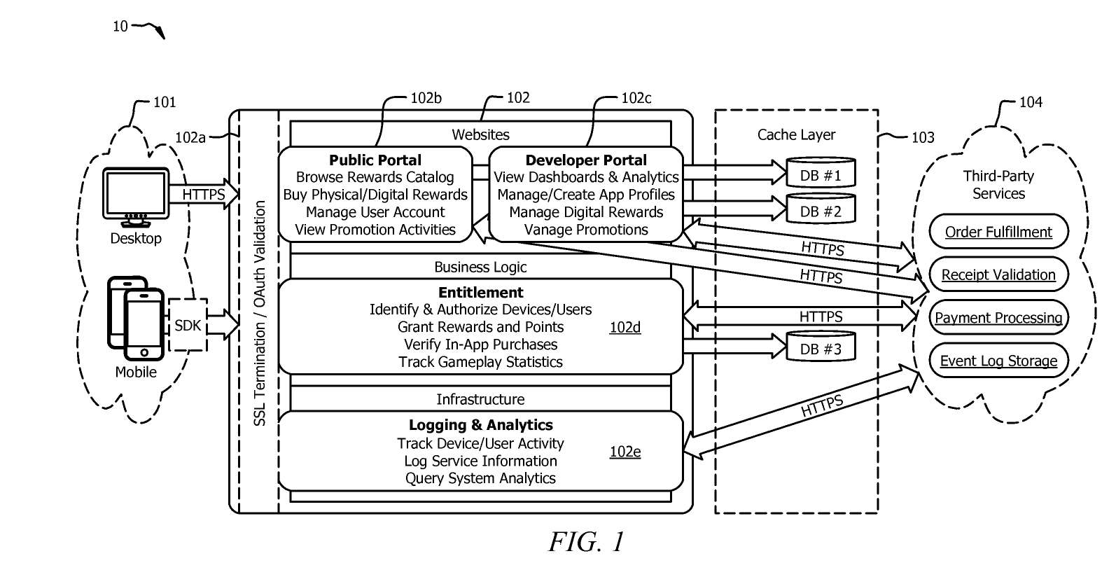

FIG. 1 depicts a network services diagram of a system for operating a loyalty platform according to an embodiment of the present disclosure. System 10 may include client side device 101, service stack 102, one or more databases 103, and one or more third-party services 104. However, it should be appreciated that more or fewer modules may be included as part of system 10 without departing from the present disclosure.

Client side device 101 may include any desktop or mobile device that a user may utilize to access service stack 102 according to embodiments of the present disclosure. In some embodiments of the present disclosure, desktop and mobile devices may include but are not limited to, mobile communication devices, laptop computers, personal computers, personal digital assistants, tablets, video game consoles/devices, and other devices that may access one or more applications through an Internet connection. It should be appreciated that client side device 101 may access the Internet through a wired or a wireless connection according to embodiments of the present disclosure. Client side device 101 may communicate with service stack 102 directly, such as over HTTPS, or through a software development kit (SDK) according to embodiments of the present disclosure. It also should be appreciated that each of the desktop or mobile devices may include some form of user interface (e.g., a display or other output device in combination with one or more input devices, including but not limited to a mouse, touch screen, joystick, wireless pointer, menu selection device, and/or remote control) to enable user selections to be provided to service stack 102 and/or to receive data from service stack 102 according to embodiments of the present disclosure.

While client side device 101 generally may communicate with service stack 102 over an Internet connection, it should be appreciated that other communication networks/techniques may be utilized to facilitate communication without departing from the present disclosure. Communication networks/techniques may include but are not limited to radio frequency, Bluetooth, infrared, USB, LAN, wireless LAN (WiLAN), worldwide interoperability for microwave access (WiMAX), WiFi, ultra-wide band (UWB), Wibree techniques, and the like. Mobile communication mechanism may include but are not limited to wide band code division multiple access (W-CDMA), CDMA2000, global system for mobile communications (GSM), general packet radio service (GPRS), long term evolution (LTE) and/or the like may be supported as well as wireless access mechanisms such as WLAN, WiMAX, and/or the like and fixed access mechanisms including but not limited to digital subscriber line (DSL), cable modems, Ethernet and/or the like.

Service stack 102 may be formed of one or more devices or nodes, such as a server or other processing device. Service stack 102 may perform one or more functions in communication with client side device 101 according to embodiments of the present disclosure. It should be appreciated that service stack 102 may be a platform, such as one or more dedicated servers or a server bank associated with one or more Internet-connected applications. Service stack 102 also may include one or more backend servers associated with the one or more Internet-connected applications. It should be appreciated that service stack 102 may be formed from one or more physical servers, cloud-based servers, and combinations of the same according to embodiments of the present disclosure.

Service stack 102 may include security/authorization layer 102a that may reside on the front end of service stack 102. In an embodiment of the present disclosure, security/authorization layer 102a may provide OAuth validation, in order that client side device 101 may have secure delegated access to service stack 102 such that client side device 101 may have such access without the operator of service stack 102 having to share credentials with client side device 101. Accordingly, client side device 101 may securely communicate with applications using OAuth validation. In an embodiment of the present disclosure, in addition to or instead of OAuth validation, security/authorization layer 102a may utilize secure sockets layer (SSL) and/or transport layer security (TLS) to secure traffic between client side device 101 and service stack 102. Security/authorization layer 102a generally may reside at the front end of service stack 102. This may be because once data is within service stack 102, it should be secure; however, it should be appreciated that there may be some embodiments of the present disclosure wherein there may be more than one security/authorization layer or the security/authorization layer may extend further within service stack 102 without departing from the present disclosure.

Service stack 102 also may include public portal 102b, which may be considered the client-facing website (such as an HTML5 website) or an application that may be displayed within client side device 101 according to an embodiment of the present disclosure. Public portal 102b may allow a user to perform various tasks including but not limited to browsing a rewards catalog, buying physical and/or digital rewards, managing a user account, and viewing promotion activities. Accordingly, public portal 102b may allow client side device 101 to interact with other aspects of service stack 102 according to embodiments of the present disclosure.

Service stack 102 may further include developer portal 102c that may be used by a developer to perform various tasks related to one or more applications according to an embodiment of the present disclosure. Tasks may include but are not limited to viewing dashboard and other analytics, managing and creating application profiles, managing digital rewards, and managing promotions according to embodiments of the present disclosure. Developer portal 102c may provide a developer with the ability to make new promotions and identify activities that may be eligible for promotions. Developers may create new applications and set up reward promotions for one or more applications using developer portal 102c.

Service stack 102 also may include entitlement portal 102d where business logic for service stack 102 may reside. Entitlement portal 102d may be used to identify and authorize users as well as the user devices being used to access one or more applications. Entitlement portal 102d may also be used to grant user rewards and points, track gameplay statistics, and verify in-application purchases according to embodiments of the present disclosure. For example, when a user completes a round of a game, entitlement portal 102d may identify that the round has been completed, update the user's statistics related to the game being played, and determine whether the user is eligible for a modifier. Entitlement portal 102d also may be utilized to execute one or more events associated with an application that may be set up in developer portal 102c, the frequency of the event (weekly, monthly, etc), what activities associated with the one or more events that may make the user eligible for a modifier if completed, and what modifier(s) may be set for engaging in one or more activities. Within a given event, entitlement portal 102d may be utilized to execute a series of activities to be completed by a user to be eligible for the modifier. For example, a user may need to play 10 rounds in a week to be eligible for a modifier (such as adding a bonus to a multiplier, increasing a multiplier by 2×, etc.) Accordingly, entitlement portal 102d may be used to execute the activities to be completed and the modifier(s) to be offered for meeting the activities.

It should be appreciated that with an achievement system for an Internet-connected application, a developer may establish criteria for achieving certain goals within the application. Those criteria may then be associated with an in-application spend threshold for the application. It should be appreciated that there may be embodiments of the present disclosure wherein the criteria and in-application spend threshold may be established within developer portal 102c. In other embodiments of the present disclosure, these criteria and in-application spend threshold may be established in whole or in part within entitlement portal 102d. In further embodiments of the present disclosure, developer portal 102c and entitlement portal 102d may work together to establish the criteria and threshold.

Service stack 102 also may include logging/analytics system 102e that may provide further infrastructure for one or more applications according to an embodiment of the present disclosure. System 102e may track when certain events occur related to an application (i.e., provide a sequential log of user actions from within an application, sometimes referred to as an events log). For example, a user may be presented with a notification of eligibility for a certain promotion or achievement of a certain modifier, and system 102e may track whether the user clicked on or otherwise accessed the notification. System 102e may also provide information as to whether the user dismissed or acted upon the notification according to an embodiment of the present disclosure. In some embodiments of the present disclosure, portal 102e may track the amount of time it took for a user to access the notification or otherwise act upon the notification. Accordingly, system 102e may track user activity related to one or more applications. System 102e also may log service information and query system analytics according to embodiments of the present disclosure. It should be appreciated that analytics according to embodiments of the present disclosure may predict future user behavior and produce actionable results. Analytics may include but are not limited to previous in-application purchase choices, previous spend, number of sessions, number of devices, game-play or application-use style, cohort membership, and demographic information.

Using these predictive analytics, systems and methods according to embodiments of the present disclosure may provide predictions of user behavior related to an application regarding future in-application purchase choices and rewards redemption. The predictive model output also may recommend events that may be designed to increase in-application purchases and enhance the user experience, including customized events and/or modifiers. In some embodiments of the present disclosure, predictive model outputs also may provide recommendations to the developer on specific strategies that may improve user retention and/or increase in-application purchases. This is important because every user that is acquired, regardless how the user began using the application, may be valuable to the developer. As such, acquisition is made more cost-effective and/or viable for the developer.

Service stack 102 may communicate with one or more databases 103 according to an embodiment of the present disclosure. It should be appreciated that one or more databases 103 may include a cache layer, such as through Redis, and/or one or more PostgreSQL databases without departing from the present disclosure. The one or more databases may each be associated with a portal within service stack 102. It should be appreciated that one or more databases 103 may be hosted on a virtual private cloud in some embodiments of the present disclosure; however, there may be other embodiments of the present disclosure wherein one or more databases may be stored on one or more physical servers without departing from the present disclosure.

Portions of service stack 102 may also communicate with one or more third-party services 104 according to an embodiment of the present disclosure. In this embodiment of the present disclosure, public portal 102b, entitlement portal 102d, logging and analytics system 102e and developer portal 102c each may communicate over HTTPS (or another similar secure transfer protocol) with one or more third-party services 104 to transfer data to and receive data from one or more third-party services 104. In this embodiment of the present disclosure, one or more third-party services 104 may include order fulfillment, receipt validation, payment processing and event log storage. However, one or more third-party services 104 may include more or fewer services without departing from the present disclosure.

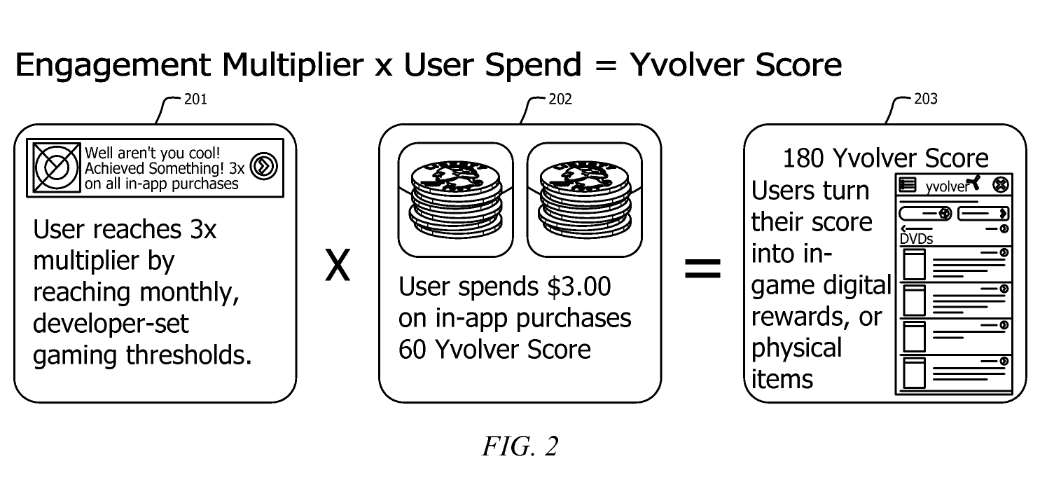

FIG. 2 depicts a flow chart of how a user score may be achieved according to an embodiment of the present disclosure. In block 201, a user may reach a certain modifier by achieving certain developer-set application use thresholds. In this embodiment of the present disclosure, the user has reached a modifier (e.g., a 3× multiplier) that may be applied to all in-application purchases by reaching monthly, developer-set thresholds. In block 201, the user may spend a certain amount of money on in-application purchases. In this embodiment of the present disclosure, the user may spend $3.00 on in-application purchases, which gives the user a score of 60. By multiplying the user's score achieved in block 202 by the modifier achieved through engagement with the application, the user may arrive at a score set forth in block 203. In this embodiment of the present disclosure, the user may have achieved a score of 180 based on applying his/her modifier to his/her spend on in-application purchases. In turn, the user may utilize his/her score to redeem in-application digital rewards and/or physical items.

It should be appreciated that opportunities to earn modifiers may be presented to users so that they do not detract from the user experience in accessing the one or more applications. For example, systems and methods avoid providing confusing pop-up notifications, blocking or otherwise impeding (even temporarily) the user's access to the application. Further, the systems and methods should not make the user believe that he/she has left the application. For example, if a user is playing a game, a notification provided according to systems and methods according to embodiments of the present disclosure should not distract the user from otherwise playing the game or make the user feel as though he/she has exited the game. Similarly, notifications according to systems and methods according to embodiments of the present disclosure should not provide distracting ads and offers that detract from the user accessing the application.

In embodiments of the present disclosure, utilizing the flow chart depicted in FIG. 2, a user who does not spend money on in-application purchases does not result in cost to the developer. If a user spends a small amount of money on in-application purchases, that user may be encouraged to spend a little more money to achieve a higher score. Accordingly, users may receive value for their engagement with the application, not just based on their purchases within the application. In turn, developers may evaluate the users' engagement and spend within the application to determine what other promotions or value that they can bring to the users.

It should be appreciated that new users of a game or Internet-connected application may be presented with different screens within the application reflecting modifiers earned (or that may be earned), events being offered, activities that have been or are available to be completed, and purchases made (or that can be made) according to embodiments of the present disclosure.

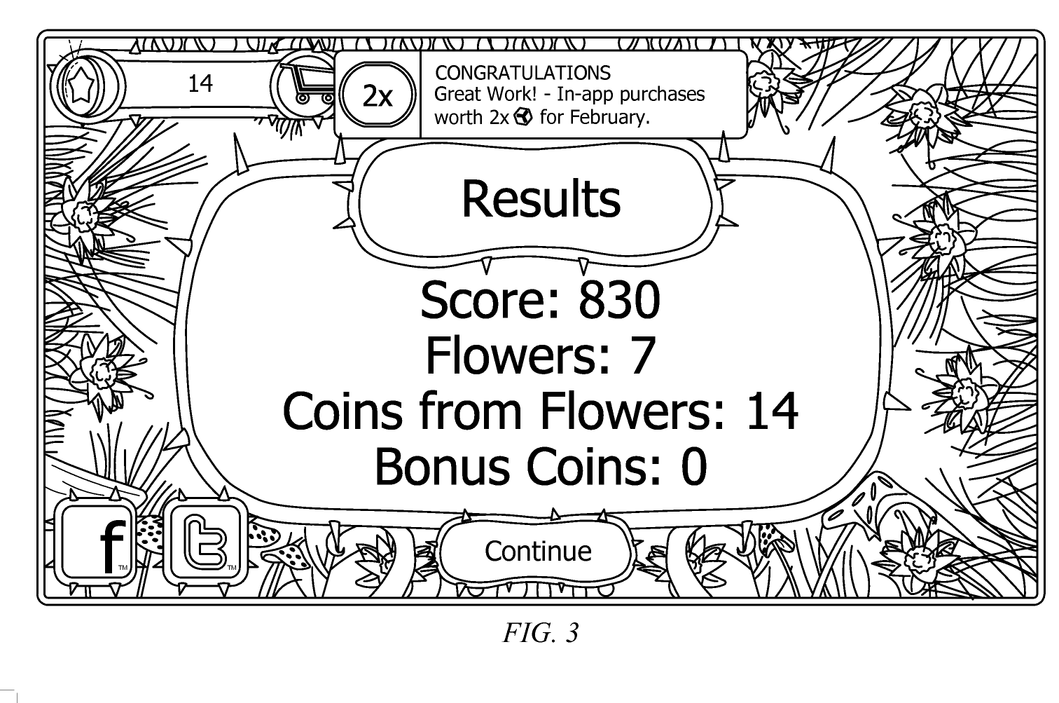

FIG. 3 depicts a screenshot of a notification that may be provided to a new user of an event. This notification may make the new user aware that he/she has earned a modifier according to an embodiment of the present disclosure. For example, the new user may be playing a game on a hardware platform, such as his/her smartphone. When the results screen appears within the game, such as at the end of a round, the new user may see a notification or a “toast” appear on the screen as he/she earns modifiers. In this embodiment of the present disclosure, the user has achieved a threshold score within the application for the month of February that entitles the user to a 2× modifier for all in-application purchases made during that month. If the user taps the notification, he/she may be presented with means to access a catalog of rewards for purchase.

It should be appreciated that the modifier that a user achieves within an Internet-connected application does not do anything for the user until the user spends money within the application or takes another action prompted by the application. The modifier plus spending within the application yields a score, and this is what the user may use to exchange for rewards according to embodiments of the present disclosure. In some embodiments of the present disclosure, the modifier may be capped on a developer-by-developer basis. In some embodiments of the present disclosure, the developer may be charged for the score as a measure of user activity and spend related to the application.

Having the modifier tied in with the user in-application spend to yield a score allows for better purchase verification by the developer or other provider of systems and methods according to embodiments of the present disclosure. More specifically, while a malicious user may be able to fake a certain activity within an Internet-connected application to drive up a modifier, it is less likely that a malicious user will elect to spend money within the application. Because the score only takes effect when the user spends money after having achieved a certain modifier, this may reduce the likelihood that a malicious user may be able to take advantage within the application. This is because the modifier does not do anything for a user until the user spends money in the application.

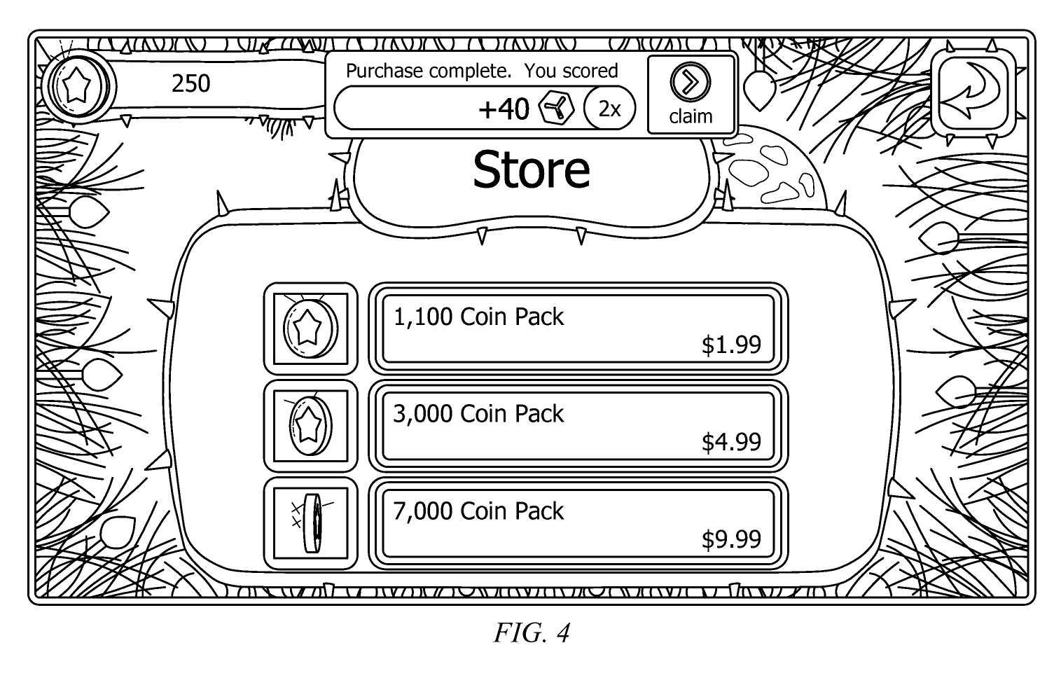

FIG. 4 depicts a screenshot of what a new user may see if he/she makes an in-application purchase according to an embodiment of the present disclosure. A user may be presented with one or more in-application purchase options. For example, the user may be presented with different coin packs that may be utilized within a game. However, for games, the user may be presented with weapon upgrade options or other extra upgrades that may be purchased for use within the application according to embodiments of the present disclosure. Once the user has made an in-application purchase, a notification or toast may appear to confirm that the user has made the in-application purchase. The notification also may inform the user what he/she has added to his/her score over a specified period of time. The notification also may include a “claim” selection mechanism that may draw the user to tap or otherwise select the notification insofar as the user will be aware that he/she is earning points toward his/her score. It should be appreciated that the user is not required to make a claim following an in-application purchase and may repeat the steps of accumulating points and making in-application purchases more than once over the specified period of time that an event is conducted according to embodiments of the present disclosure.

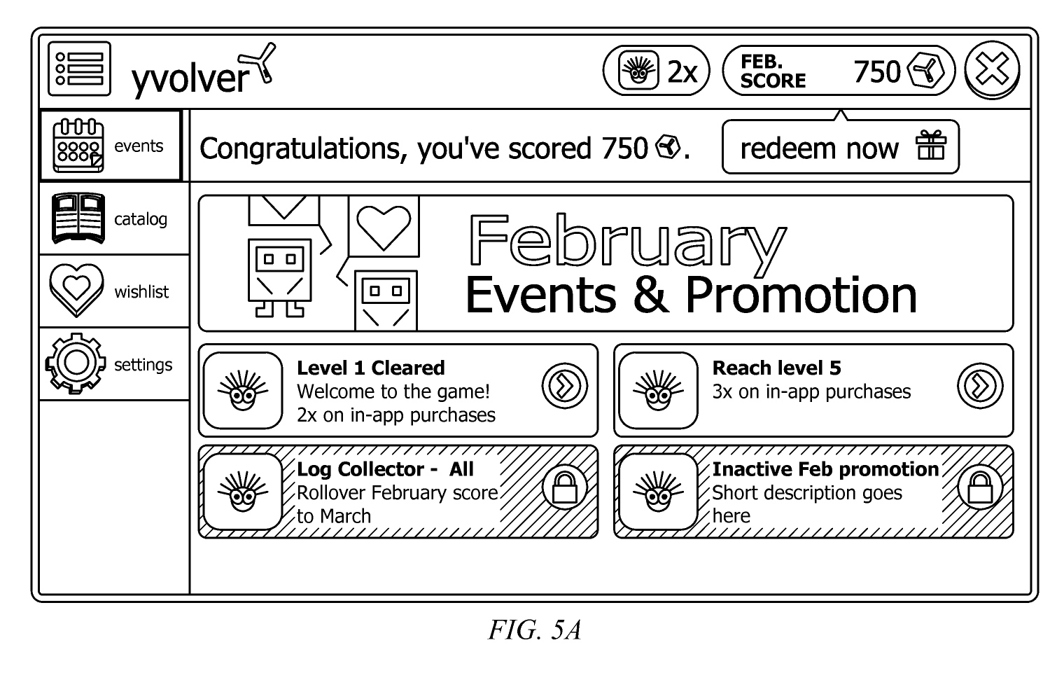

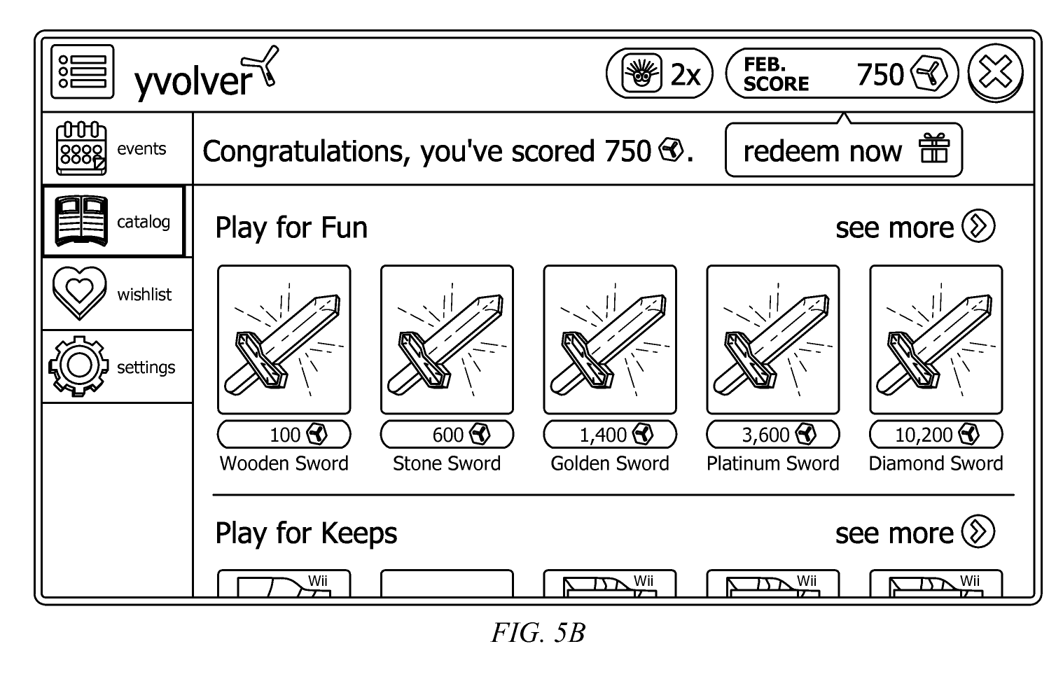

FIG. 5A depicts a screenshot of an events screen depicting incomplete and complete activities for a specified period of time (i.e., a month) according to an embodiment of the present disclosure. A user of the game or other Internet-connected application may view one or more events associated with use of the game or Internet-connected application. It should be appreciated that the user may view the events in their entirety; however, there may be embodiments of the present disclosure where the user may filter the events based on one or more criteria without departing from the present disclosure. In this embodiment of the present disclosure, the user may receive a modifier (e.g., a 2× multiplier) on in-application purchases upon clearing the first level of the game. Another event may be to earn a modifier (e.g., a 3× multiplier) on in-application purchases. In a further event, a user may be permitted to rollover his/her score from one month to the next. It should be appreciated that more or fewer events may be presented to a user without departing from the present disclosure. The events screen may include a “redeem now” or “claim now” callout or other similar notification that may prompt the user to sign in and claim his/her points. In this embodiment of the present disclosure, the user may tap on a “catalog” selection button.

FIG. 5B depicts a screenshot of what a new user may see if he/she views the catalog on the events screen according to an embodiment of the present disclosure. The user may be presented with one or more rewards for which he/she may be eligible. If the user is interested in one or more of the rewards, then he/she may tap the “redeem” button or otherwise opt in to redeem/claim a reward, and the user may be presented with an account setup screen according to an embodiment of the present disclosure.

FIGS. 3-5B have depicted examples of screens that may be presented to a new user of a game or Internet-connected application in order to encourage the new user to access the application and earn a modifier that may translate to digital and/or physical rewards. It should be appreciated that an existing user of a game or Internet-connected application may be presented with similar or different screens without departing from the present disclosure. For example, an existing user may be presented with the same screen as depicted in FIG. 3 as he/she completes activities associated with a particular event. Similarly, FIG. 4 depicts a screenshot of what an existing user may see once he/she has received some points and wants to see what the points can be redeemed for or if he/she wishes to check for new events.

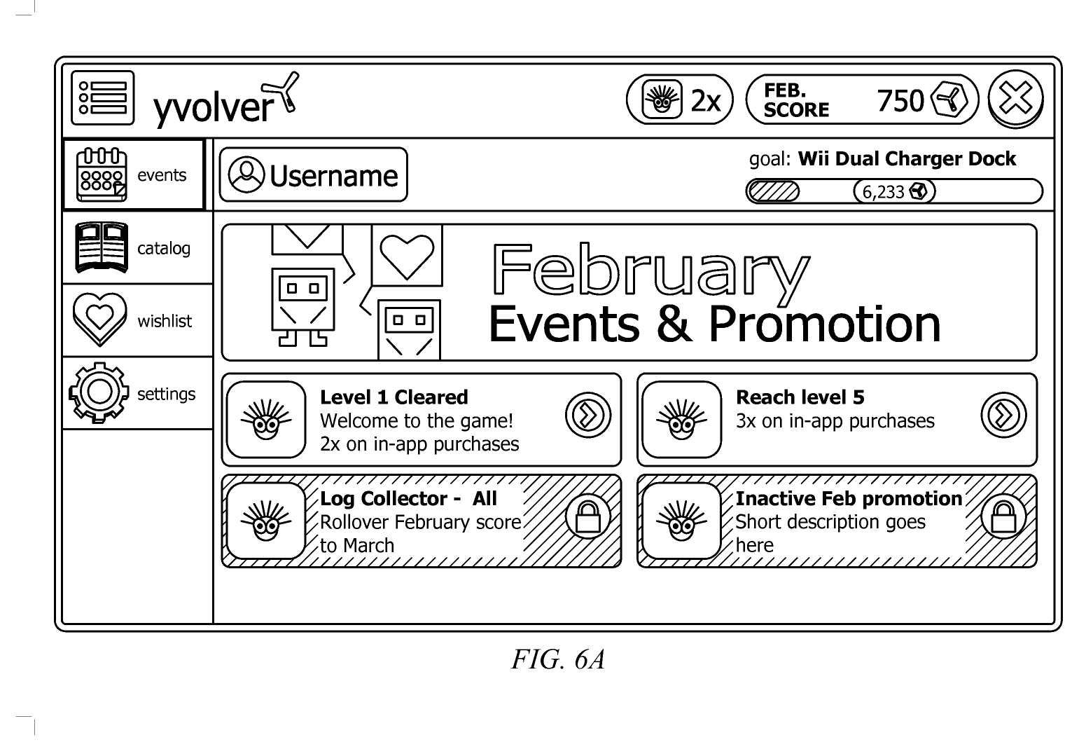

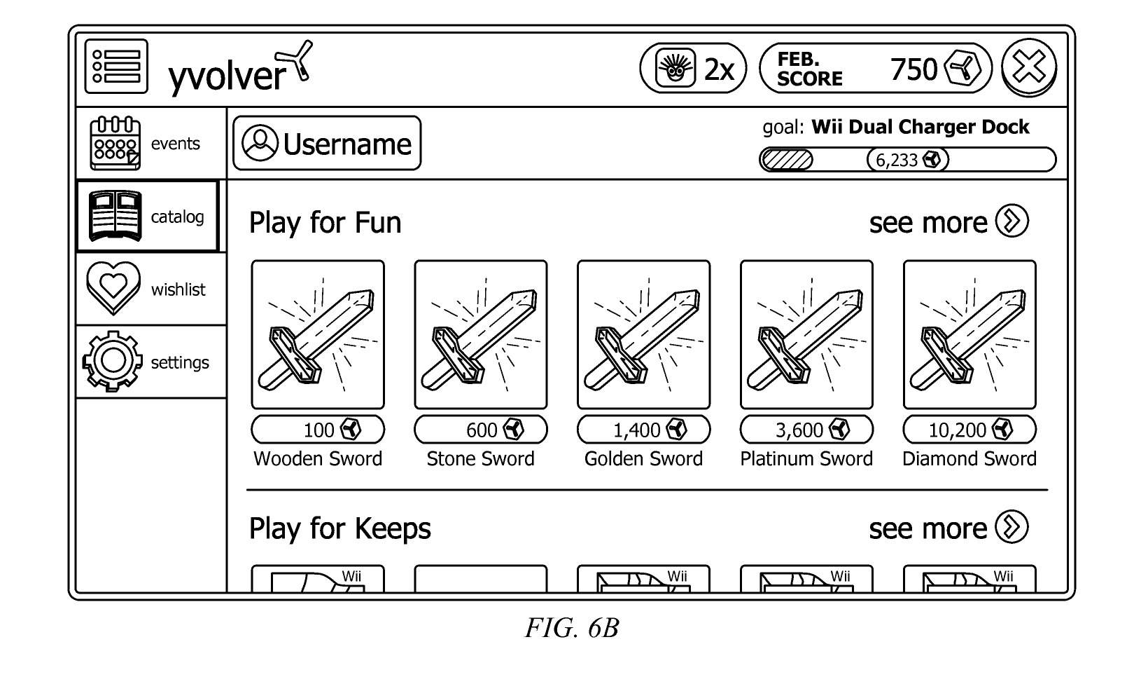

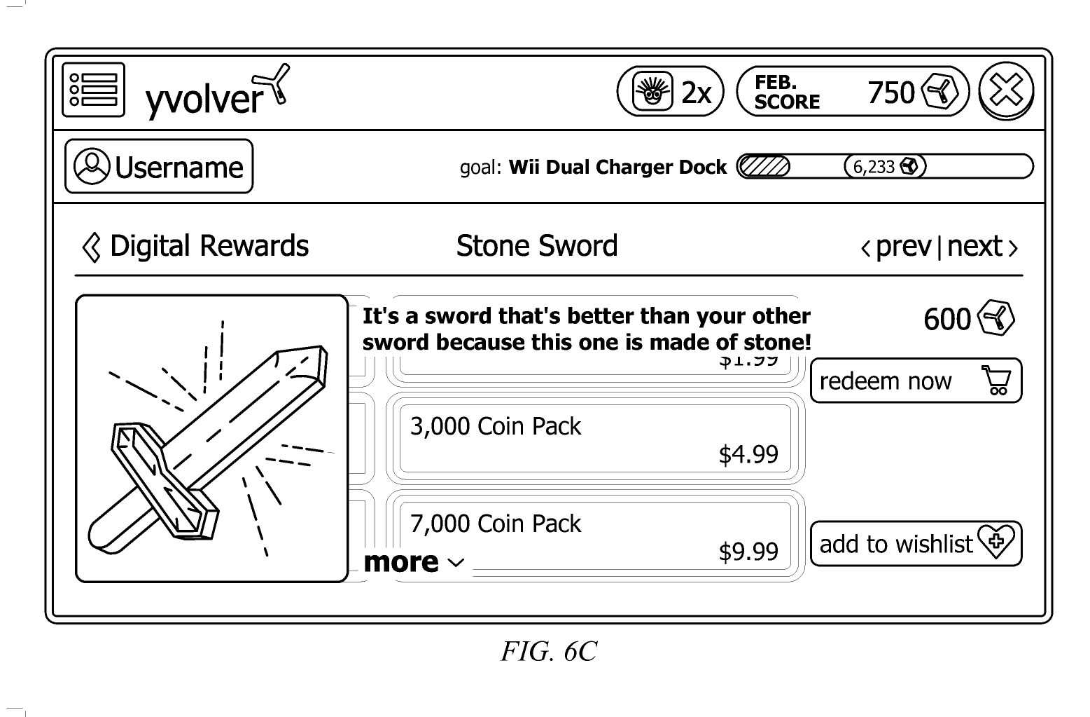

FIG. 6A depicts a screenshot of an events screen depicting incomplete and complete activities for a specified period of time (i.e., a month) according to an embodiment of the present disclosure. FIG. 6A differs from what a new user might see (FIG. 5A) insofar as an existing user may have a profile/username link that may be displayed on the events screen. However, it should be appreciated that other means for indicating that a user is an existing user may be utilized without departing from the present disclosure. An existing user also may be presented with information concerning a goal that he/she may be working toward. In the embodiment depicted in FIG. 6A, the user may be working to redeem his/her points for a Wii Dual Charger Dock.

FIG. 6B depicts a screenshot of what an existing user may see if he/she views the catalog screen according to an embodiment of the present disclosure. In this embodiment of the present disclosure, the user may be aware that he/she has accumulated enough points to redeem a certain reward, and the user may elect to tap or otherwise select the desired reward. It should be appreciated that both digital and physical rewards may be presented to a user according to embodiments of the present disclosure. It also should be appreciated that there may be embodiments of the present disclosure wherein the user may be presented with digital and/or physical rewards that he/she may not yet be able to claim because he/she has not achieved a threshold score to claim the reward. By presenting rewards that are not available to the user, this may incentivize the user to continue to accumulate points within the application so that he/she may later claim a desired reward. It should be appreciated that more or fewer digital and/or physical rewards may be presented without departing from the present disclosure. It also should be appreciated that a goal reward may be established for the user or the user may establish a goal reward according to embodiments of the present disclosure. In this embodiment, the goal is a Wii Dual Charger Dock, and a sliding scale may be presented to visually demonstrate to the user how close he/she may be to achieving that goal.

FIG. 6C depicts a screenshot allowing the existing user to confirm that he/she wishes to redeem the reward selected in FIG. 6B according to an embodiment of the present disclosure. If the existing user is satisfied that this is the reward that he/she intended to select, the existing user may tap the “redeem” button or otherwise indicate that he/she wishes to redeem the reward. Upon doing so, the existing user may be taken to a redemption/confirmation screen.

While certain embodiments of the present disclosure have been described in connection with a gaming application, it should be appreciated that systems and methods according to embodiments of the present disclosure may extend to Internet-connected applications other than games. For example, there may be applications where users purchase items (such as Amazon.com), and systems and methods according to embodiments of the present disclosure may be utilized to encourage users to make purchases using the specified website. In an embodiment of the present disclosure, the application provider may allow users to accumulate a score based on social media activity combined with the user's in-application spend. Accordingly, once the user spends a certain amount of money within the application, he/she may achieve a score that may be used to purchase physical and/or digital items.

While certain digital and/or physical rewards have been described in embodiments of the present disclosure, it should be appreciated that the rewards may be unlimited in nature and type but generally are not ads or offers. There may be some embodiments of the present disclosure where digital items may include in-application items, including exclusive items or items that may be available for a limited amount of time. Physical items may include exclusive, game-related physical merchandise, but it should be appreciated that physical items also may have no formal association with the application in which a score was achieved. Systems and methods according to embodiments of the present disclosure may provide a massive catalog of physical goods in addition to covering fulfillment and store customer service rewards. It should be appreciated that physical goods may be wide-ranging in price and the catalog may be continuously updated and additions may be made. It also should be appreciated that the catalog of rewards also may be tailored for the range of the target audience according to embodiments of the present disclosure. By offering these types of physical and digital items as rewards, real, obvious and measurable value may be provided to the user for continuing to achieve points toward his/her score.

While certain embodiments of the present disclosure have been described as utilizing mobile communication devices, such as smartphones, it should be appreciated that systems and methods according to embodiments of the present disclosure also may be utilized on other hardware platforms, including but not limited to, a smartphone, a laptop, a personal computer, a video game console/device, a tablet, or other communication devices having an Internet connection. There also may be embodiments of the present disclosure wherein the systems and methods may be utilized with an augmented or virtual reality device.

A user may achieve a persistent score across a plurality of Internet-connected applications and/or hardware platforms according to embodiments of the present disclosure. As such, a user's score may not be limited to his/her use of a single game application. It also should be appreciated that users may be able to achieve a score related to an application utilizing more than one hardware platform without departing from the present disclosure (i.e., by logging in using his/her user profile on different devices). There also may be embodiments of the present disclosure where a user may add to his/her score by utilizing more than one Internet-connected application. Once a user has accumulated a threshold score (using one or more Internet-connected applications) where he/she may be eligible for a reward, the catalog of physical and digital items may be browsable and selectable on any hardware platform.

It should be appreciated that users may interact with an Internet-connected application over multiple sessions and may be presented with more than one opportunity to accept or reject in-application purchase offers that, if accepted, may add to the user's score. For example, a user playing a game may be asked if he/she wishes to buy an extra life for $0.99. Systems and methods according to embodiments of the present disclosure may observe the choices that users make within an application over time and help developers understand how their relationship with each individual user may evolve over time. By giving users the right incentives and rewards to engage in in-application purchases, this may lead to increased organic acquisition by the developer through word-of-mouth and/or improved application ratings as well as increased retention of existing users at a lower cost through improved satisfaction, and this leads to an increase in revenues for the developer.

It also should be appreciated that, in order to drive user behavior within an Internet-based application, a developer may direct what it wants users to do within the application, and this may differ from application to application. In some embodiments of the present disclosure, the developer and/or provider of the systems and methods may receive periodic data concerning usage of the application and behaviors of users related to the application. This may allow systems and methods to make automatic or real-time recommendations as to what behaviors should be addressed by the developer or provider.

It should further be appreciated that a single provider may manage the systems and methods according to embodiments of the present disclosure. In such embodiments, the systems and methods may overlay on one or more Internet-connected applications. In this type of overlay, the provider may be managing the systems and methods, but the user of an Internet-based application may not recognize that he/she is interacting with an overlaid system within the Internet-connected application. However, there may be other embodiments of the present disclosure wherein an application provider may operate the systems and methods itself within the application.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for operating a loyalty platform for an Internet-connected application, the system comprising:
a points, status and rewards administration center housed on one or more servers, and accessing one or more databases to manage events, activities within the events, modifiers, user spend, and rewards on the Internet-connected application,
wherein the administration center provides a user of the Internet-connected application with opportunities to earn one or more modifiers based on completion of one or more activities within an event that, when combined with the user spend within the Internet-connected application, influences present and future user activity within the Internet-connected application.

2. The system of claim 1 wherein the Internet-connected application is utilized by a user on at least one hardware platform, the at least one hardware platform selected from the group comprising:
a mobile communication device, a tablet, a laptop computer, a personal computer, a personal digital assistant, an augmented/virtual reality device, and a video game console.

3. The system of claim 1 wherein the one or more modifiers are selected from the group comprising:
a multiplier, a status, points, an additive percentage and combinations of the same.

4. The system of claim 1 wherein user activity comprises:
making purchases within the Internet-connected application, increasing usage of the Internet-connected application, and completing activities within the Internet-connected application.

5. The system of claim 1, the points, status and rewards administration center comprising:
a public portal displayed within the Internet-connected application to the user;
a developer portal to manage events and rewards associated with the Internet-connected application; and
an entitlement portal housing the business logic for the points, status and rewards administration center, the business logic comprising management of events associated with the Internet-connected application, rewards, points, modifiers, activities eligible for modifiers, and in-application purchases.

6. The system of claim 5, wherein the public portal, the developer portal and the entitlement portal access one or more third-party services, the one or more third-party services selected from the group comprising:
order fulfillment, receipt validation, payment processing, and event log storage.

7. The system of claim 1, the points, status and rewards administration center further comprising:
a logging and analytics system that tracks device and user activity and queries system analytics related to the Internet-connected application.

8. A system for managing rewards for use of an Internet-connected application, the system comprising:
one or more client side devices accessing the Internet-connected application over a communication network to view events, earn modifiers, and make in-application purchases, that when combined, result in a score that is redeemable for the rewards for use of the Internet-connected application;
a service stack having one or more servers that communicate with the one or more client side devices accessing the Internet-connected application, wherein the service stack manages the events, modifiers, in-application purchases, and rewards associated with the Internet-connected application; and
one or more databases accessed by the service stack to store and access information related to usage of the Internet-connected application by the one or more client side devices.

9. The system of claim 8 wherein the one or more client side devices are selected from the group comprising:
a mobile communication device, a tablet, a laptop computer, a personal computer, a personal digital assistant, an augmented/virtual reality device, and a video game console.

10. The system of claim 8 wherein the events associated with the Internet-connected application are available for a specified period of time.

11. The system of claim 8 wherein the score comprises:
the modifier within the Internet-connected application based on user achievement associated with the event multiplied by the value of the in-application purchases.

12. The system of claim 8 wherein the rewards are digital and physical items.

13. A method for operating a loyalty platform for one or more Internet-connected applications, the method comprising:
providing a user with a threshold for use of the one or more Internet-connected applications over a specified period of time;
awarding a user with a modifier when the user reaches the threshold for use of the one or more Internet-connected applications over the specified period of time;
prompting the user to make one or more in-application purchases; and
combining the modifier with the dollar value of the one or more in-application purchases to assign the user a score, wherein the score is redeemed for one or more rewards,
wherein the threshold, the modifier, and the one or more in-application purchases made by the user are stored on one or more databases accessed over a communication network and are managed on a service stack.

14. The method of claim 13 wherein the specified period of time is selected from the group comprising:
an hour, a day, a week, a month, a quarter, and a year.

15. The method of claim 13 wherein the prompting step is performed by providing the user with a notification on the hardware platform used to access the one or more Internet-connected applications.

16. The method of claim 13 wherein the user is awarded a modifier by reaching the threshold from use of a single Internet-connected application.

17. The method of claim 13 wherein the user is awarded a modifier by reaching the threshold based on use of a more than one Internet-connected application.

18. The method of claim 13 wherein the one or more rewards are digital and physical items.

19. The method of claim 13 further comprising:
using the service stack, tracking device and user activity and predicting future user behavior related to the one or more Internet-connected applications.

20. The method of claim 19 wherein the user activity comprises:
purchase of items within the one or more Internet-connected applications, increase in usage of the one or more Internet-connected applications, and completion of activities within the one or more Internet-connected applications.
